(19) United States
(12) Patent Application Publication
(10) Pub. No.: US 2001/0039532 A1
(43) Pub. Date: Nov. 8, 2001

(54) Chargeback calculator

(76) Inventors: William Edward Coleman JR., Hillsborough, NC (US); William Alphus Godley, Raleigh, NC (US); Wilbur Randolph Stafford, Raleigh, NC (US)

Correspondence Address: DAVID J LEVY, VP INTELLECTUAL PROPERTY, GLAXO WELLCOME INC, GLOBAL INTELLECTUAL PROPERTY, FIVE MOORE DR, PO BOX 13398, RESEARCH TRIANGLE PARK, NC, 27709-3398, US

(21) Appl. No.: 09/829,664

(22) Filed: Apr. 10, 2001

Related U.S. Application Data
(60) Provisional application No. 60/196,440, filed on Apr. 11, 2000.

(51) Int. Cl. G06F 17/60

(52) U.S. Cl. 705/39

(57) ABSTRACT

A method and system for resolving chargeback discrepancies. By utilizing electronic discrepancy resolution, a number of discrepancies resolved per time period can be reduced. Moreover, by actively analyzing which areas are creating frequent discrepancies, an account administrator can notify a plan participant early such that continued errors can be avoided.

### CROSS-REFERENCE TO CO-PENDING APPLICATIONS

The present application claims priority to and is related to co-pending U.S. Provisional Application Ser. No. 60/196,440, filed Apr. 11, 2000, the contents of which are incorporated herein by reference.

### BACKGROUND OF THE INVENTION

1. Field of the Invention

The present invention is generally directed to reimbursing a first party for goods or services sold by a second party. One exemplary use of the present invention relates to a method, system and computer program product for reconciling chargeback amounts in a business-to-business collaborative environment (e.g., in a prescription drug distribution system).

2. Discussion of the Background

Chargebacks are a standard operating practice in the pharmaceutical industry. Chargeback payments are used by pharmaceutical manufacturers to reimburse wholesalers for products sold under a manufacturer's discounted price contract. The chargeback payment amount represents the difference between a Net Wholesale Price (NWP) and the discounted contract price negotiated between the manufacturer and Group Purchasing Organizations (GPO).

Institutions managed under the GPO corporate entity buy products directly from a wholesaler under a GPO contract for which they are an eligible member. This transaction initiates the chargeback from the wholesaler to the manufacturer. To summarize the overall process flow, the wholesaler buys product from the manufacturer at NWP, sells it to an institution under specific GPO contract pricing terms, and then “charges back” the difference to manufacturer. The difference is netted out with a credit to the wholesalers.

Chargeback payment requests from the wholesalers can be processed without any errors/discrepancies. However, due to the nature and volatility of the contract and the demand for accuracy in the chargeback transaction, transaction errors do occur. Errors result when the wholesaler information regarding the transaction does not match the manufacturer's information. Mismatching information could include contract numbers, institution (DEA/HIN) identifiers, membership eligibility, product (NDC), price, etc. When this happens, the manufacturer rejects the chargeback request and a reconciliation process with the wholesaler is begun to resolve the discrepancy. While the majority of chargeback requests are processed without errors, there is still a significant volume of transactions (over 60,000 per month) that are rejected and must go through the reconciliation process. The vast majority of chargeback rejections/disputes occur because of membership issues.

The current process flow for chargeback processing inside of Glaxo Smith Kline, the assignee of the present application, typically includes the following major steps:

(1) Wholesalers submit their chargeback request to via Electronic Data Exchange (EDI);

(2) Glaxo Smith Kline receives the initial chargeback request, validates the content of the chargeback transaction, and either (i) accepts the transaction for credit, or (ii) rejects the transaction, thereby initiating the reconciliation process;

(3) As the first step in the reconciliation process, Glaxo Smith KIine returns the rejected chargeback detail line items to the wholesalers via EDI or paper in the form of a Chargeback Credit Memo Reconciliation Report;

(4) The wholesaler evaluates the rejected items and can elect to (i) accept the rejection, (ii) resubmit as is, or (iii) correct and resubmit;

(5) Resubmission of the chargeback request is accomplished only via paper;

(6) Glaxo Smith Kline processes the paper-based resubmitted chargeback requests; and

(7) Glaxo Smith Kline returns the reconciled chargeback request to the wholesalers via EDI or paper (Chargeback Credit Memo Reconciliation Report).

### SUMMARY OF THE PRESENT INVENTION

It is an object of the present invention to address chargeback discrepancies, such as those that pose an industry-wide problem in the pharmaceutical industry.

This object and other advantages are addressed by a contract administration and membership component that helps to facilitate the communications of membership changes between a Contract Operations group of a manufacturer, the Wholesalers, the institutions, and the GPO's. One of the major benefits in facilitating the communication of membership changes is to speed up the process of getting the correct membership recorded within the wholesalers' and manufacturer's systems. This results in fewer chargeback rejections.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1A is a schematic illustration of a computer for providing the services of the present invention;

FIG. 1B is a schematic illustration of one embodiment of the computer of FIG. 1A providing the services of the present invention;

FIG. 2 is a data diagram of the major functions performed by and the data used by the present invention;

FIG. 3A is a data flow diagram of how information is distributed according to one embodiment of the present invention;

FIG. 3B is a more detailed data flow diagram of how information is distributed according to one embodiment of the present invention;

FIG. 4 is a diagram showing where various features of the present invention are carried out;

FIG. 5A is an illustrative screenshot showing a first embodiment of how a wholesaler can request information about chargebacks;

FIG. 5B is an illustrative screenshot showing how a debit memo search may be performed according to one embodiment of the present invention:

FIG. 6 is an illustrative screenshot showing the results of the request of FIG. 5B;

FIG. 7 is an illustrative screenshot showing the details of the disputed items corresponding to the request of FIG. 5B and allowing the modification thereof;

FIG. 8 is an illustrative screenshot showing a second embodiment of how a wholesaler can request information about chargebacks;

FIG. 9 is an illustrative screenshot showing a scorecard selected using the interface of FIG. 8; and

FIG. 10 is an illustrative screenshot showing a global update tool.

### DESCRIPTION OF THE PREFERRED EMBODIMENTS

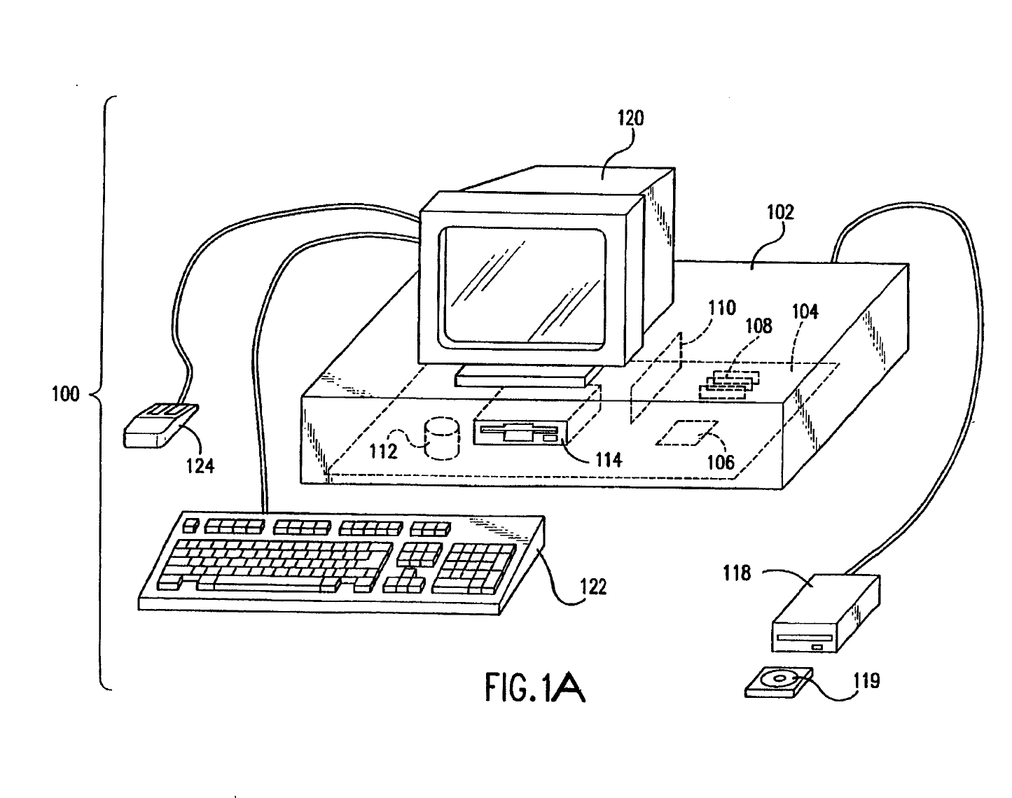

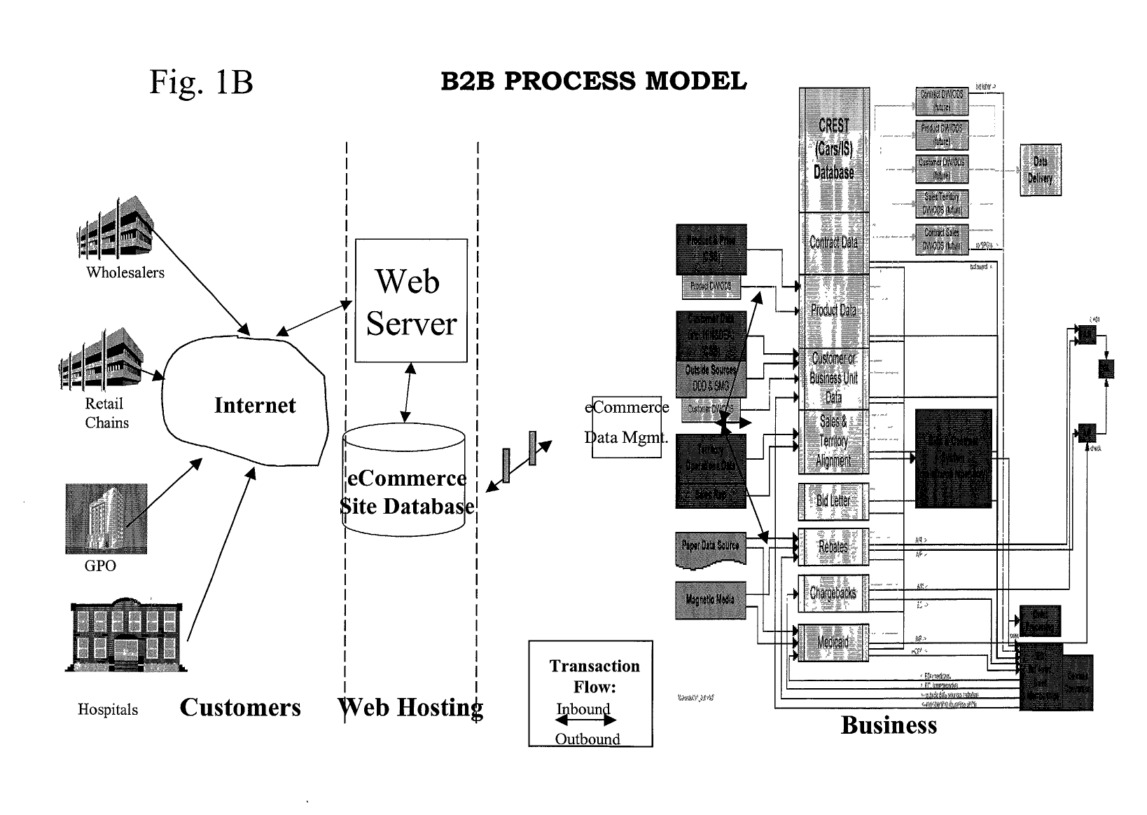

Referring now to the drawings, in which like reference numerals designate identical or corresponding parts throughout the several views, FIG. 1 is a schematic illustration of a computer system for managing chargebacks using a wide area network (e.g., the Internet). A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of chargebacks.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. In the broadest sense, even the transmission lines of computer network adapters (e.g., modems, Ethernet, token ring and ATM) are computer readable media since code and/or data may be read from them. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for providing chargeback analysis. The computer code devices of the present invention can be any interpreted or executable code mechanism, including but not limited to scripts (including Active Server pages and Java Server pages), interpreters, dynamic link libraries, Java classes, and complete executable programs. These computer code devices may run on either one of, or on a combination of, a client and a server computer. Information on providing Web services is provided in the following references which are incorporated herein by reference: (1) Visual Studio Core Reference Set, by Microsoft Press, (2) Visual InterDev 6.0: Web Technologies Reference, by Microsoft Press, (3) Professional Active Server Pages 2.0 by Francis et al., published by WROX Press Ltd., (4) Oracle PL/SQL Programming by Scott Urman, Published: March 1996, (5) Hitchhikers Guide to Visual Basic and SQL Server: with CD-ROM, by William Vaughn, Published: May 1997, (6) Using Microsoft SQL Server 6.5 (Special Edition) by Stephen Wynkoop, Published: March 1997, and (7) Advanced PowerBuilder 6 Techniques by Ramesh Chandak.

In order to reduce the number of chargeback discrepancies, membership records are updated frequently (e.g., once every n days (where n≦1) versus once a month). Thus, chargeback rejections will result for only those n days versus a month. As would be apparent to one of ordinary skill in the art from this disclosure, the frequency for updating can be made longer or shorter depending on a balancing between system load and increased discrepancies.

By using the present invention, wholesale customers and manufacturers submit and resolve chargeback resubmissions online. Denied chargeback requests are reconciled by correcting mismatched information, and the requests are resubmitted (if appropriate) to the manufacturer.

As shown in FIG. 1B, in order to provide this functionality, the present invention utilizes an eCommerce Database (DB) populated with chargeback data from the Chargeback System and from customer entered parameters. Examples of applicable databases include any SQL server from Microsoft, Oracle or others, as well as non-SQL databases (e.g., relational or object-based databases). Flat files can also be used in place of a database, especially where the data in the flat file may be presented in a structured format (e.g., XML).

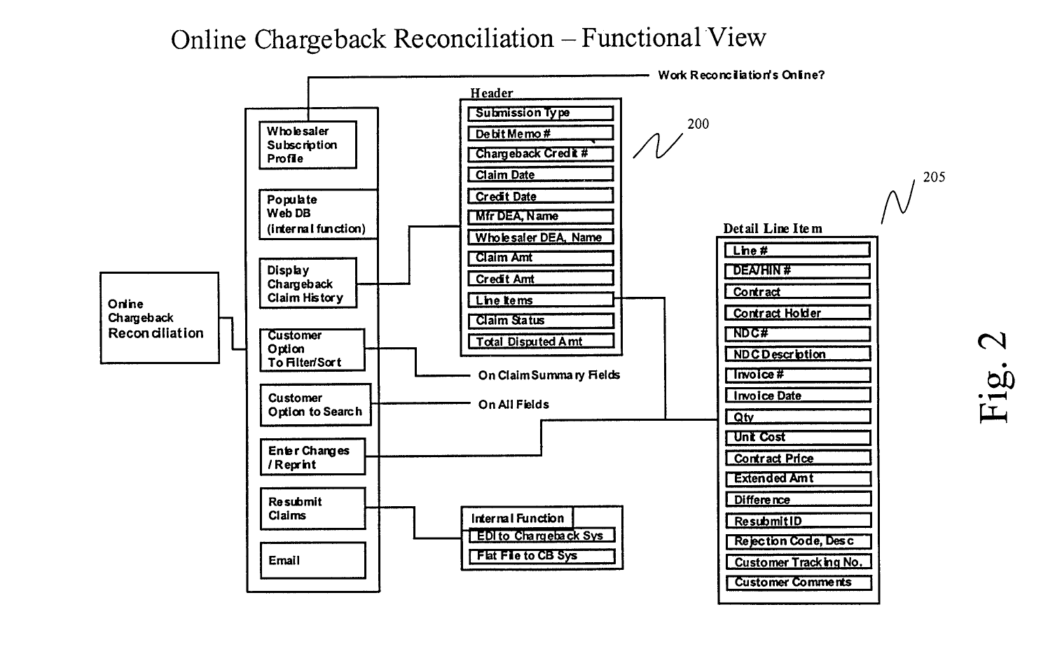

For those customers that have selected to have chargeback reconciliation performed electronically, historical chargeback data is made available for viewing online. As shown in FIG. 2, this includes header information 200 for all chargeback claims submitted within a specified period (e.g., the past 6 months). In one embodiment, due to the sheer volume of chargeback data, only rejected or partially rejected line items for claims will be displayed. (Such line items include: (1) detail lines that were not paid, (2) detail lines that were partially paid, and (3) detail lines that were fully paid but adjusted from the original submission). The chargeback claim history should be searchable by all fields of chargeback information and sorted by claim summary fields. The system will store personalized search/sort criteria for users. As records are viewed, the system will display the manufacturer's status assigned by the Chargeback System.

Disputed information can then be entered or changed on-line using detailed line items 205. The customer will have the option of working multiple line items/records before submitting a batch of them to the manufacturer. Those changes/updates will be tracked as a part of the normal Chargeback System process.

Once all information is changed, claims (e.g., formatted as an EDI or XML file, or as a flat file) may be resubmitted. This file, extracted from the eCommerce database on a scheduled basis, will then be provided as input into Chargeback System normal processing.

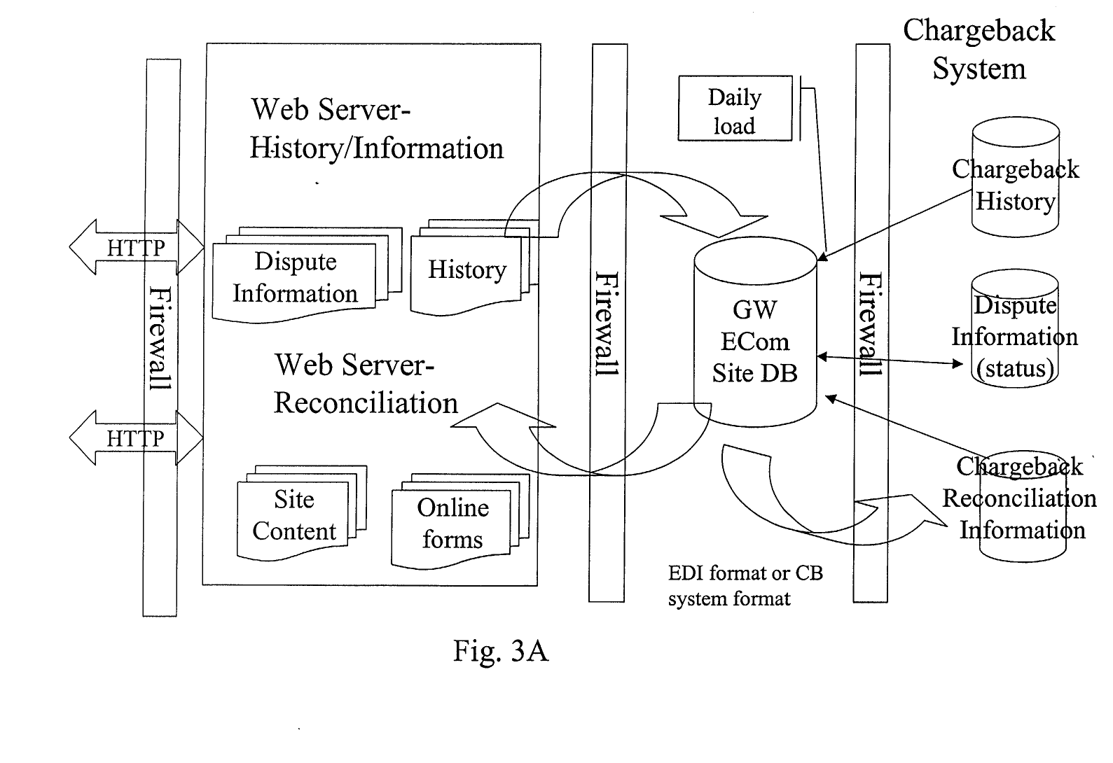

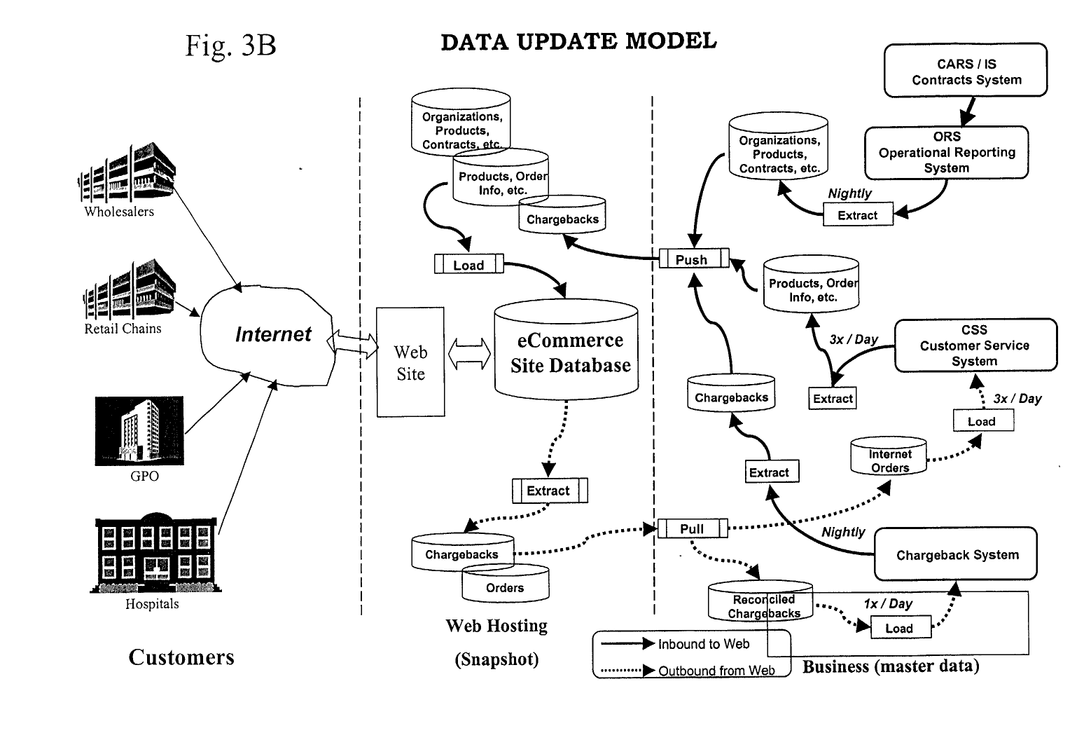

The data flow of the present invention as described above is illustrated in simplified form in FIG. 3A. Generally, data requests are sent from businesses/customers across a wide area network (e.g., the Internet) using a request transfer protocol (e.g., HyperText Transfer Protocol (HTTP), File Transfer Protocol (FTP), or Gopher Information Services). Those requests are received by an information server (e.g., Web server implementing a Web site) configured to listen to the corresponding type of request (e.g., HTTP requests). For requests for static information, such as general information and forms that are independent of the user, the information server can satisfy the request directly. Some other requests, though, require that data be retrieved in order to respond to the request. The information server then queries a database (e.g., an eCommerce database) to provide the necessary information. In one embodiment, the data in the database is updated in real-time, and in an alternate embodiment, the data is a snapshot of the actual data. In FIG. 3A, the database is loaded with a snapshot of three different information sources (i.e., a chargeback history database, a dispute information database, and a chargeback reconciliation information database) daily. As also seen in FIG. 3A, various components of the system may be distributed between several computers, optionally separated by firewalls for added security.

In the embodiment illustrated in FIG. 3B, the updating of the database is illustrated as occurring at different rates for different activities. Various information is pushed out of master databases and placed into snapshot databases. The data from the snapshot databases is then loaded into an eCommerce database accessible by the information server. (In an alternate embodiment, the snapshot database and the eCommerce database are merged into a single database that information is imported into directly and from which data is extracted for direct transmission to the master database.)

As users interact with the information server, it updates data in the eCommerce database which eventually must be extracted for transmission back to the master databases. Such data is either pulled (as illustrated) or pushed so that it arrives to a point that is accessible to the master system(s). The new chargeback data is then loaded into the chargeback system (e.g., once a day). Similarly, data corresponding to orders taken over the WAN (e.g., the Internet or a private medical WAN) are loaded into a customer service system periodically (e.g., more frequently than the data is loaded into the chargeback system). Data is also extracted from the customer service system periodically (e.g., three times a day) in order to update a snapshot of the products database that can be shipped out from the master system for importation into the eCommerce database. Similarly, the contracts and reporting systems can export data that is also transferred to the eCommerce database.

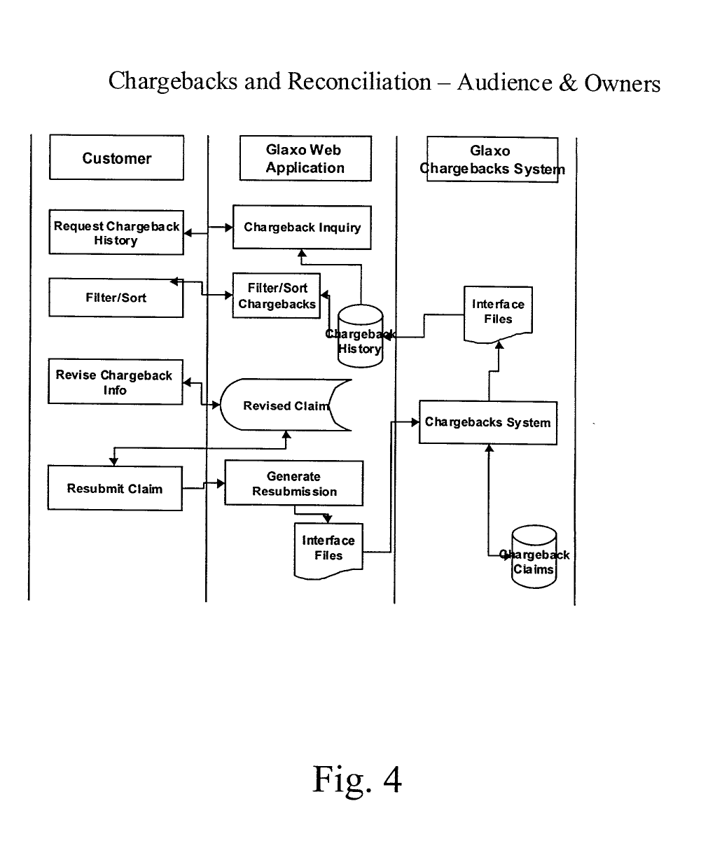

In light of the vast amount of data that is likely to be generated in a commercial system as described above, filters and/or sorting criteria are provided to keep the data presented to users to a manageable level. As shown in FIG. 4, a chargeback history is available, but a filter/sort option is preferable to an unfiltered data dump. Nonetheless, using either a filtered or unfiltered interface, at least one chargeback in dispute can be selected and revised based on a customer's request. Having revised the chargeback claim to correct any discrepancies, the customer resubmits the chargeback, which is eventually imported into the chargeback system (as described above with reference to FIG. 3B).

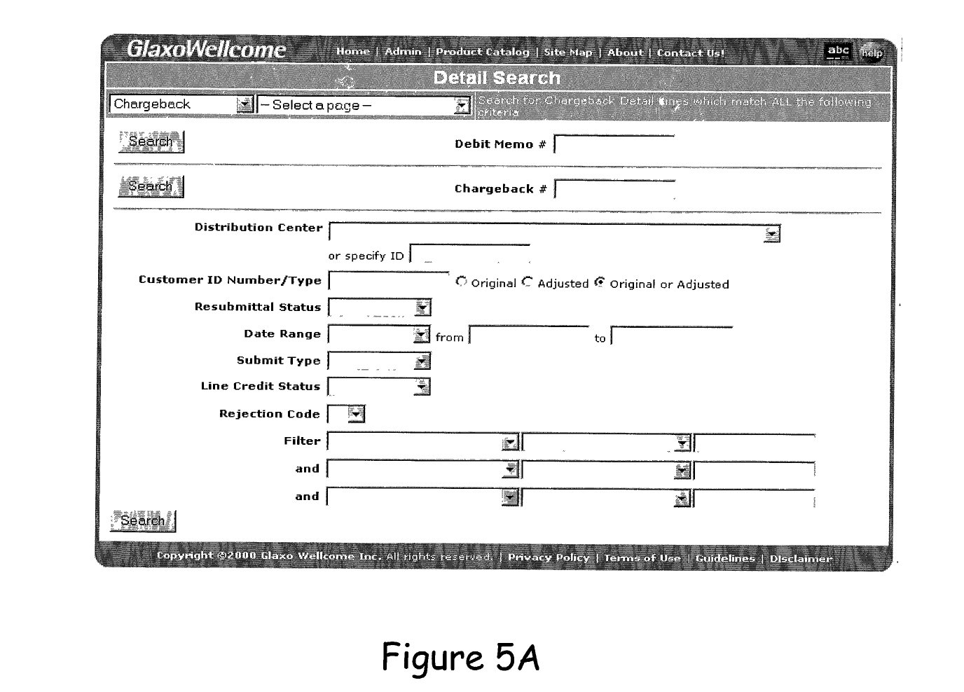

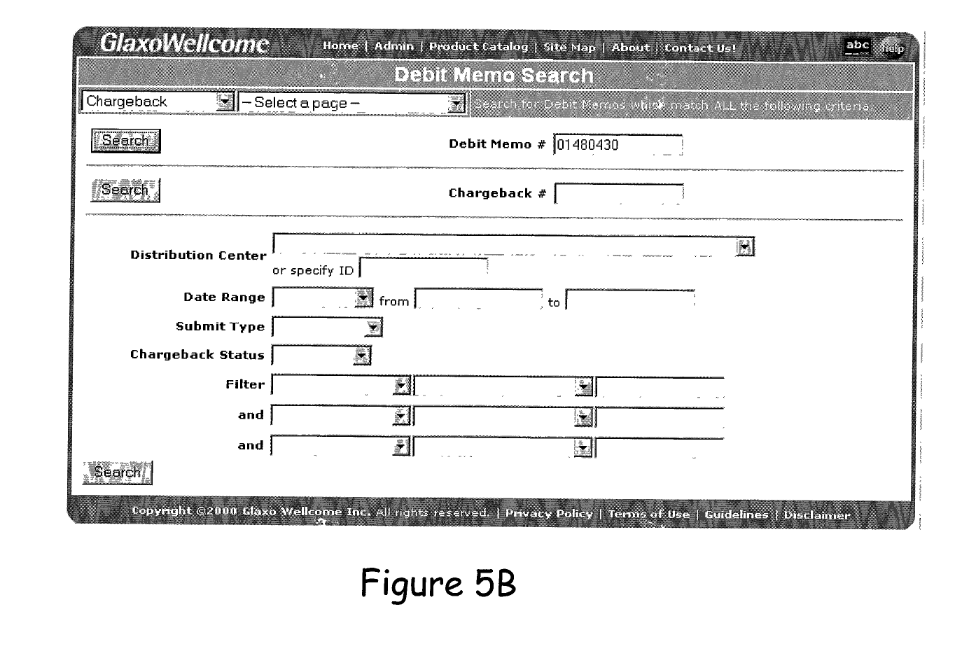

FIG. 5A illustrates one possible method of filtering/sorting data for easier analysis by customers.. Chargebacks can be sorted by fields including, but not limited to, all of a customer's distribution centers, select customer distribution centers, and wholesaler reference identifiers. Also, more specific criteria (e.g., debit memo numbers, chargeback numbers, data ranges and selectable filter conditions) further specify conditions to be matched to reduce the number of displayed records. As would be appreciated by one of ordinary skill in the art, the same filter may be used by an account administrator/coordinator to administer chargebacks within the manufacturer whose goods are sold. Using the interface, the account administrator can determine which customers are having trouble with which type of chargebacks.

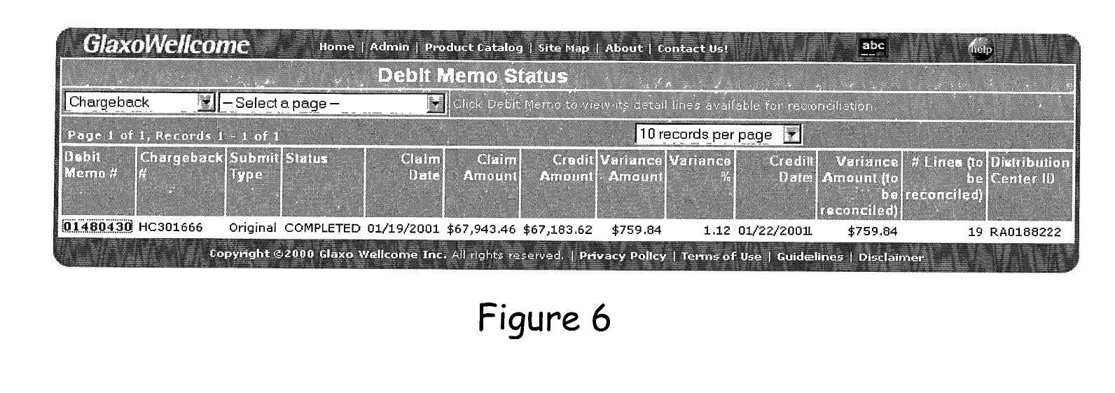

FIG. 5B illustrates an exemplary use of the search capability described in regard to FIG. 5A. As shown in FIG. 5B, a debit memo number (e.g., “01480430”) may be entered by the customer as the criteria by which the chargebacks are to be searched. FIG. 6 shows an exemplary display of summary information obtained by the web server searching the eCommerce database based on the criteria entered through search request capability described in regard to FIGS. 5A and 5B. As shown in FIG. 6, the results of the exemplary search shown in FIG. 5B summarizes the claim amount, disputed amount and other parameters that allow a customer (or account administrator) to quickly understand the nature of the dispute. Note that the Debit Memo # corresponds to the debit memo number entered in the search request of FIG. 5B (i.e., “01480430”).

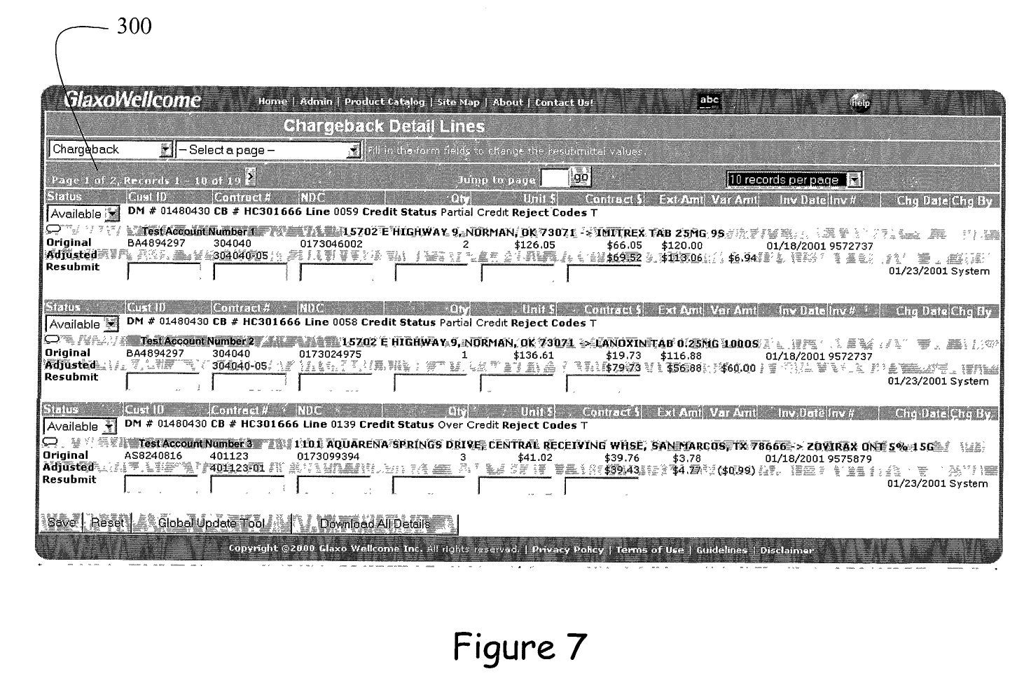

By selecting the hyperlink corresponding to the “Debit Memo #” field, the customer initiates another data request that obtains detailed line items from the eCommerce database corresponding to the individual chargeback records for the debit memo number selected (e.g., “01480430”). As shown in the summary area 300 of FIG. 7, the “DM#” field having a value of “01480430” corresponds to nineteen disputed transactions. The first three disputed transactions—two for customer “BA4894297” and one for customer “AS8240816”—are initially displayed within the user interface.

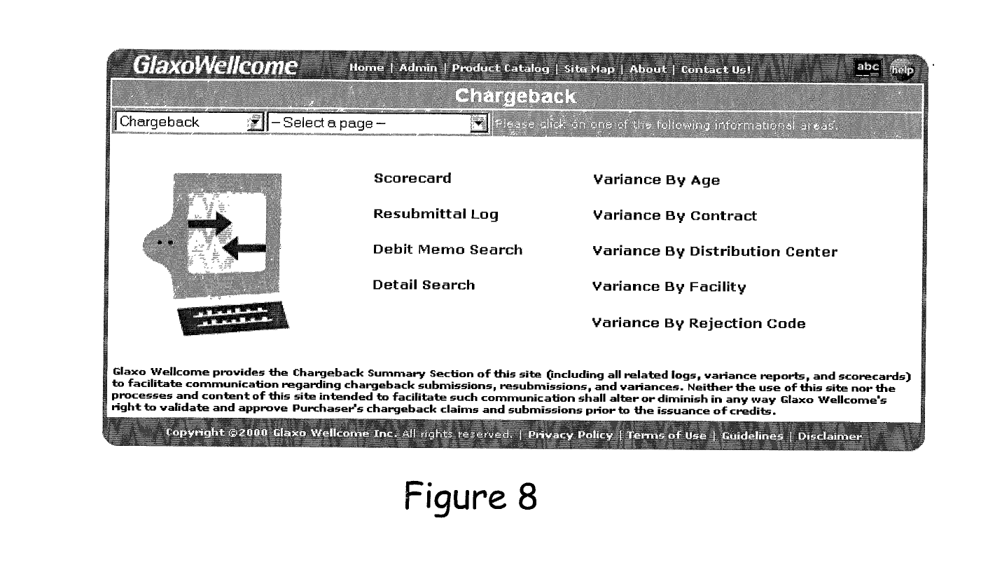

FIG. 8 illustrates an alternate embodiment of a user interface according to the present invention. In addition to being able to search based on debit memos or chargeback details, a user interface according to this embodiment also provides the option to look at chargebacks that have been resubmitted. Such a feature enables the user to track chargebacks that were previously disputed to see if the dispute has been resolved.

In an effort to track and efficiently correct the problems associated with particular customers, the present invention optionally also provides a series of pre-stored filters that help to identify major problem areas. By ranking problem areas by criteria (e.g., age of claim, contract, distribution center, facility or rejection code), a customer may more quickly identify errors in procedure.

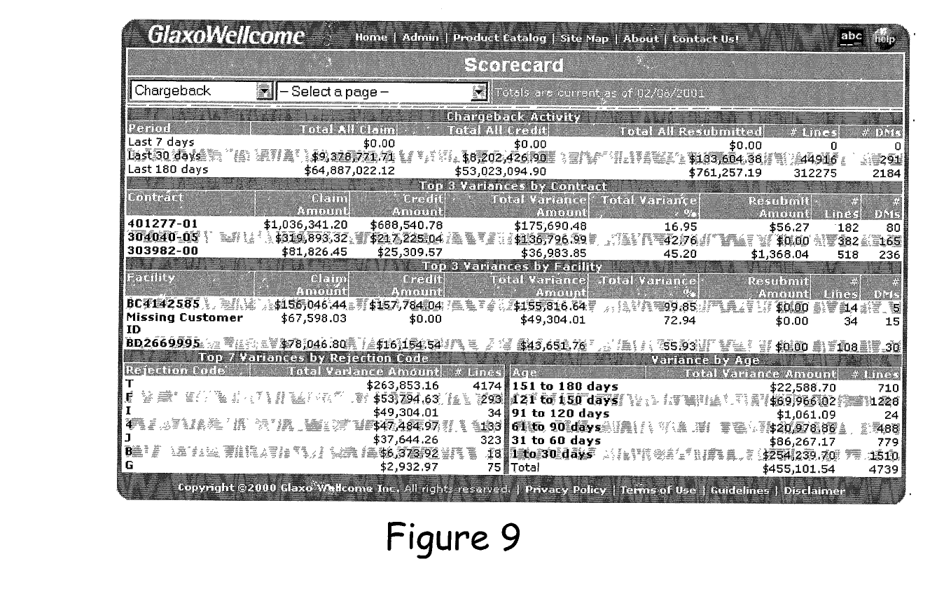

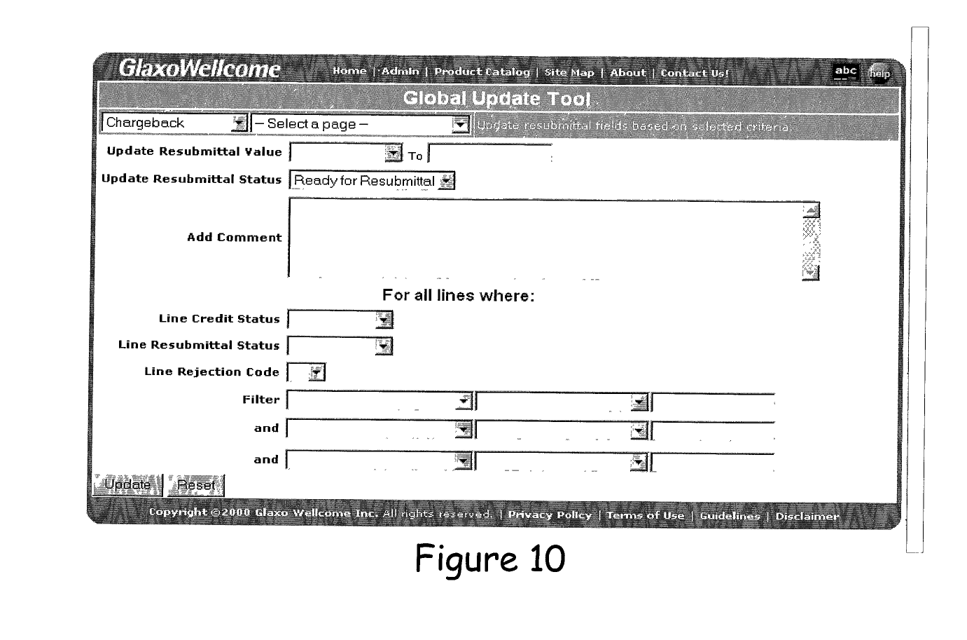

Moreover, a scorecard, such as is shown in FIG. 9, provides a summary of the results of at least two of the pre-stored filters illustrated in FIG. 8. In the exemplary results, the top 3 variances by contract and top 3 variances by facility account for in excess of $349,000 and $248,000, respectively. Perhaps more importantly, the top 3 variance by contract account for more than 1,000 lines of disputed transactions. By correcting the data entry causing those errors, significant work may be avoided. (As would be appreciated by one of ordinary skill in the art, the types and number of variances can be set by the interface designer or customer in order to more closely tailor the error tracking to an individual customer's needs.) Rather than require each disputed entry to be updated individually, one embodiment of the present invention utilizes a global update tool, as shown in FIG. 10. The Global Update Tool provides a way for users (or administrators) to make changes to many detail lines at one time. There are two types of “global” changes that this tool can be used for: (1) changes to resubmittal values or (2) changes to resubmittal status. The flow for changing resubmittal values includes the following steps: (1) select a resubmittal field to be changed, (2) enter the value that the resubmittal field is to be changed to, (3) provide the selection criteria for the lines to be changed, and (4) press/select the “Update” button or option. One possible use of the global update tool is to add or change a contract code associated with all the detailed line items where a contract code changed for a new fiscal year and the user forgot to enter the new code. By selecting a date range and the old code, the user can update all the incorrect codes across multiple detail lines in a single operation. The present inventors have recognized that having a global update tool provides significant advantages. For example, rather than addressing problems one detail line at a time, having a global update tool provides a way to globally address a single problem that may be affecting multiple detail lines with a single action.

In one embodiment of the global update tool, the user (or administrator) is provided the option of reviewing a list of all the line items that will be changed as a result of the global update prior to the update so that the user may cancel the update. (Also, since multiple users may be updating line items at a time, the present invention provides checkpoint and rollback capabilities to prevent multiple writers to the same line items.)

As would be further appreciated by one of ordinary skill in the art, various security measures will preferably be used to prevent unauthorized use of the system and/or data updates. In addition to tracking the validity of each request as it comes in, in one embodiment the user interface changes depending on the access rights of the user currently using the interface. For example, the interface may present to a less trusted user the ability to only browse chargebacks while letting a more trusted user resubmit chargebacks.

Moreover, in addition to access control, the present invention is preferably augmented with auditing to track who has made each of the submissions, resubmissions and queries. Such tracking not only helps to identify which users need additional training, it also enables the present invention to track if users are reviewing transactions that they were not intended to review.

Obviously, numerous modifications and variations of the present invention are possible in light of the above teachings. It is therefore to be understood that, within the scope of the appended claims, the invention may be practiced otherwise than as specifically described herein.

1. A computer program product, comprising:a computer storage medium and a computer program code mechanism embedded in the computer storage medium for causing a computer to resolve chargeback discrepancies, the computer program code mechanism comprising:
a first computer code device configured to read in rules associated with a contract;
a second computer code device configured to read in chargeback requests associated with the rules of the contract;
a third computer code device configured to compare the chargeback requests against the rules of the contract; and
a fourth computer code device configured to produce electronic discrepancy notices for chargeback requests that are not in compliance with the rules of the contract.

2. The computer program product as claimed in claim 1, further comprising a fifth computer code device configured to receive an electronic change to at least one previously submitted chargeback request that was not in compliance with the rules of the contract.

3. The computer program product as claimed in claim 1, further comprising:
a fifth computer code device configured to find all previously submitted chargeback requests that were not in compliance with the rules of the contract and that match at least one specified search criterion;
a sixth computer code device configured to specify a new value for at least one field common to all chargeback requests found by the fifth computer code device; and
a seventh computer code device configured to change the at least one field common to all chargeback requests found by the fifth computer code device to the new value specified by the sixth computer code device.

4. The computer program product as claimed in claim 3, wherein the seventh computer code device comprises a checkpoint and rollback computer code device.

5. The computer program product as claimed in claim 1, wherein the fourth computer code device comprises a fifth computer code device for filtering the electronic discrepancy notices according to at least one filter criterion.

6. The computer program product as claimed in claim 1, wherein the fourth computer code device comprises a fifth computer code device for filtering the electronic discrepancy notices plural times according to plural criteria and providing a scoreboard of most frequently occurring discrepancies for each of the plural criteria.

7. A computer-implemented method comprising:
reading in compliance rules associated with a contract;
reading in chargeback requests associated with the rules of the contract;
comparing the chargeback requests against the rules of the contract; and
producing electronic discrepancy notices for chargeback requests that are not in compliance with the rules of the contract.

8. The method as claimed in claim 7, further comprising receiving an electronic change to at least one previously submitted chargeback request that was not in compliance with the rules of the contract.

9. The method as claimed in claim 7, further comprising:
finding all previously submitted chargeback requests that were not in compliance with the rules of the contract and that match at least one specified search criterion;
specifying a new value for at least one field common to all chargeback requests found in the finding step; and
changing the at least one field common to all chargeback requests found by the finding step to the new value specified by the specifying step.

10. The method as claimed in claim 9, wherein the step of changing comprises utilizing a checkpoint and rollback method.

11. The method as claimed in claim 7, wherein the producing step comprises filtering the electronic discrepancy notices according to at least one filter criterion.

12. The method as claimed in claim 7, wherein the producing step comprises filtering the electronic discrepancy notices plural times according to plural criteria and providing a scoreboard of most frequently occurring discrepancies for each of the plural criteria.

13. A chargeback system, comprising:
means for reading in compliance rules associated with a contract;
means for reading in chargeback requests associated with the rules of the contract;
means for comparing the chargeback requests against the rules of the contract; and
means for producing electronic discrepancy notices for chargeback requests that are not in compliance with the rules of the contract.
